(19) United States
(12) Patent Application Publication
(10) Pub. No.: US 2006/0146861 A1
(43) Pub. Date: Jul. 6, 2006

(54) System and Method for Communication over a Network with Extended Frequency Range

(76) Inventor: Ryuji Maeda, San Diego, CA (US)

Correspondence Address: Carr & Associates, Ste. 900, 9595 Wilshire Blvd., Beverly Hills, CA, 90212, US

(21) Appl. No.: 10/905,174

(22) Filed: Dec. 20, 2004

(51) Int. Cl. H04L 12/413

(52) U.S. Cl. 370/448

(57) ABSTRACT

A communication system comprising a network having a legacy band and an extendable frequency band, a head end, and a user end, wherein said head end processes and splits source data into multiple signals and transmits said multiple signals over multiple physical channels over said extendable frequency band, and wherein said user end containing multiple receivers and a data reconstructor receives said multiple signals and recovers said source data. Another embodiment includes a communication system comprising a network having a legacy band and an extendable frequency band, a head end; and a user end, wherein said user end processes and splits source data into multiple signals and transmits said multiple signals over multiple physical channels over said extendable frequency band and wherein said head end receives said multiple signals and recovers said source data. Other embodiments include methods of communication over a network having a legacy band and an extendable frequency band.

### FIELD OF THE INVENTION

This invention relates generally to communication systems and in particular to communications over cable or wired networks primary designed for transmission of television and data signals. The present invention relates to data (or signal) transfers from the one or more head ends to the one or more user ends, i.e., the “forward path” or “downstream” and from the one or more user ends to the one ore more head ends, i.e., the “return path” or “upstream”.

### BACKGROUND OF INVENTION

As the number of internet users and the popularity of transferring large sized data increases, there has been a tremendous demand for systems that can serve a higher number of users (i.e., systems with a higher “capacity”) and provide those users with larger data within a short time duration (i.e., high data transfer rate or data rate). High demand for high data transfer rate is inevitable as applications which require vast amount of data being transferred per unit time continue to emerge.

Presently, in the United States, the most common communication systems that offer high data rate (“broadband” or “high speed”) to commercial internet users are digital subscriber line (“DSL”) and cable modem systems. Fiber to the home (“FTTH”) provides very high data rate, but even with the recent advances in optical technologies, the cost of bring in the connection to the house (“the last mile”) is still prohibitively higher compared to those two widely adapted technologies. Therefore, it is highly desired that the data transfer rate of the widely adapted cost effective technologies is improved.

The majority of current cable systems are based on Hybrid Fiber-Coax (HFC) architecture, which provides two-way, high-speed data access to the home, business, and the like using a combination of optical fiber and traditional coaxial cable along with electrical, optical, and electro-optical elements. An HFC network is an example of a wired network, even though it has optical fibers and other components. In FIG. 1 a block diagram of a prior art HFC cable system is shown. Head end 101 interfaces to optical network 100. Optical network 100 consists of optoelectronic transceiver nodes 105 and optical fiber network 106. Optical network 100 may contain elements such as optical amplifiers, hubs, splitters, etc. which are not shown in FIG. 1. Transceiver nodes 105 convert downstream optical signals to electrical signals and convert upstream electrical signals to optical signals. Distribution amplifiers 107 are used to compensate for any signal losses encountered while the signals propagate through the coaxial cable network 108. Note that distribution amplifiers 107 provide amplification to both downstream and upstream signals. The coaxial cable network 108 distributes signals to sub trees 109, which are consist of various user ends such as cable modem (CM) 110, set top box (STB) 112, digital cable TV, and so on. The coaxial cable network 108 and sub trees 109 may contain other elements such as signal splitters, taps, and other elements which are not shown in FIG. 1. Signals generated or received by cable modem termination system (CMTS) 102 are respectively sent or received through downstream (DS) 103 or upstream (US) 104 blocks. As can be seen from FIG. 1, downstream (DS) 103 may split a signal into several optoelectronic transceiver nodes 111 at which the electrical signals are converted to optical signals. Similarly, the optoelectronic transceiver nodes 111 connected to upstream (US) 104 convert return-path optical signals to electrical signals and the signals may be combined at upstream (US) 104 block. In the following paragraphs and figures, those multiplicities of DS and US signals are not shown. Note that downstream (DS) 103 and upstream (US) 104 blocks may contain frequency converters.

FIG. 2 depicts a prior art DOCSIS (Data Over Cable Service Interface Specification) cable modem 161 connected to hybrid fiber coax (HFC) network 150 through a coax cable 151. The current version of US DOCSIS, version 2.0, assigns downstream spectrum to 88 MHz to 860 MHz and upstream spectrum to 5 MHz to 42 MHz. Downstream signals occupying the downstream spectrum enters the DOCSIS cable modem 161 through coax cable 151 which is connected to F-connector 152. Diplexer 153 is a frequency selective block which consists of a high pass filter (HPF) for downstream and a low pass filter (LPF) for upstream. Diplexer 153 isolates the upstream signal path from the downstream path while allowing a common connector to be used to connect to HFC network 150. Tuner 154 tunes to a certain channel located in the downstream spectrum and produces, after appropriate amplification, filtering, and frequency conversion, and other similar processes, either intermediate frequency (IF) or baseband output signal that is fed to the analog to digital converter (ADC) in DOCSIS cable modem element or a data re-constructor 155. The gain of Tuner 154 is controlled by DOCSIS cable modem element 155. The ADC produces digital signals which are subsequently demodulated, error detected and corrected. Security processing, equalization, and any other required processes may also be applied to the demodulated data. For transmission of upstream data, the data is encoded for forward error correction, modulated, and then converted to analog signal by the digital to analog converter (DAC). The DAC output signal is filtered by BPF 159, whose intended function is to avoid undesired folding of signals to the desired transmission signal band. PA 160 amplifies the filtered signal and the amplified signal passes through the LPF portion of the diplexer 153 before the transmission signal leaves the DOCSIS cable modem 161 to the HFC network 150. The gain of PA 160 is controlled by DOCSIS cable modem element 155. A media access control (MAC) within a DOCSIS cable modem element 155 functions as a “master” within the DOCSIS cable modem 161, which governs various functions such as assigning upstream frequency and time slots, compensating cable delays, adjusting upstream power level, etc. The DOCSIS cable modem element 155 may contain a memory interface to external memory 156. A user's computer 158 is connected to the DOCSIS cable modem 161 through Ethernet PHY 157. A newer cable modem device may include a wireless LAN interface.

FIG. 3 shows the spectrum allocation (not to scale) based on DOCSIS Radio Frequency Interface Specification, SP-RFIv1.1-106-001215. In FIG. 3 the shaded areas represent channel bandwidths, which are 6 MHz for each downstream channel and 200, 400, 800, 1600, or 3200 kHz for each upstream.

Some attempts in improving data transfer rate have been made. For instance, Chapman, et al. (U.S. Published Application No. 2004/0163129) has shown a way to improve down-stream data rate for a cable system based on the DOCSIS standard. However, this reference does not support up-stream high data rate and also a significant reduction in capacity is expected if a high data rate was to be maintained for all the participating users of the system since the current DOCSIS standard allocate radio frequency (RF) spectrum for down stream only up to 860 MHz.

There is also prior art technology that takes advantage of the broad band nature of an HFC network and allocates additional down stream and up stream RF bands in the approximately 1 GHz to 3 GHz frequency range which is not currently utilized. A block diagram of this type of prior art is depicted in FIG. 4. Frequency converter 203 up-converts an additional downstream band to approximately 1 to 2 GHz and down-converts an additional upstream band centered around 2.3 GHz to the approximately 10 to 42 MHz. Wideband amplifiers 204 and wideband passives 205 replaces existing blocks whose frequency range is limited to about 1 GHz. At the user's premise, frequency converter 206 is placed external to the user's end equipment 207 and 208. Frequency Converter 206 down-converts the additional downstream band back to the 50 MHz to 860 MHz band and up-converts the upstream signals out of the multiple cable modems to the 2.3 GHz band. The added signals are handled by fiber node 202, which employs wavelength division multiplexing (WDM). The optical signals are sent/received through optical fiber network 201. At head end 200, the upstream optical signals are converted to electrical signals and further processed to recover each data stream from the user's end equipment 207 and 208. At head end 200, the downstream electrical signals are converted to optical signals for transmission though the optical fiber network 201. Even though this technology utilizes the “extended” RF spectrum and provides vastly higher capacity than the existing DOCSIS system, it does not provide users higher data transfer rate per modem.

### BRIEF DESCRIPTION OF THE DRAWINGS

FIG. 1 is a block diagram of a prior art cable system consists of Hybrid Fiber Coax (HFC) cable network, head end and user end equipment;

FIG. 2 is an illustration of a prior art DOCSIS cable modem connected to a HFC network via a coaxial cable;

FIG. 3 is an illustration of signal spectrum assigned for upstream and downstream path by US DOCSIS;

FIG. 4 is an illustration of a prior art high capacity cable system utilizing frequencies above 860 MHz;

FIG. 5 is an illustration of an example of a set of frequency bands added to above the legacy band;

FIG. 5A is a detailed illustration of an example of a new upstream band;

FIG. 5B is a detailed illustration of an example of a new downstream band;

FIG. 6 is a block diagram of a system capable of high data rate communication while achieving high network capacity;

FIG. 7 is another block diagram of a system capable of high data rate communication while achieving high network capacity;

FIG. 8 is an illustration of multi-duplexer operation;

FIG. 9 is an illustration of an example of high data rate receiver utilizing two receivers utilizing two different physical channel bandwidths;

FIG. 9A is a flowchart showing processes when there is a failed physical channel(s) while in communication;

FIG. 9B is another flowchart showing processes when there is a failed physical channel(s) while in communication;

FIG. 10 is an illustration of an example of high data rate cable modem capable of maximally two times the data transfer rate of a legacy cable modem;

FIG. 11 is an illustration of an example of high data rate digital video receiver capable of maximally three times the data transfer rate of a legacy digital video receiver;

FIG. 12 is an illustration of example of a versatile high data rate set top box capable of receiving maximally three times the data transfer rate of a legacy digital video receiver, receiving and transmitting data maximally two times the data transfer rate of a legacy cable modem, and supporting legacy analog TV/VCR;

FIG. 13 is an illustration of high data rate capable cable system supporting various cable equipment including legacy user ends and high data rate capable user ends.

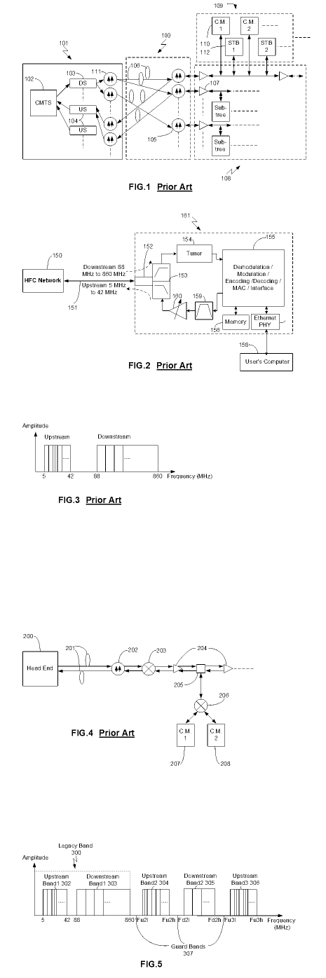

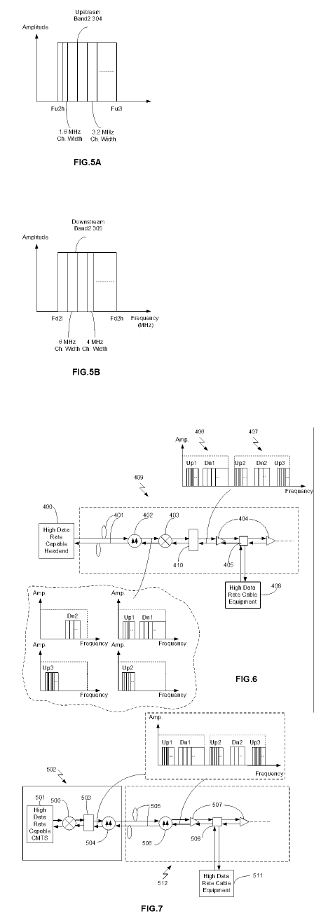

### DETAILED DESCRIPTION OF THE EMBODIMENTS

Embodiments of the claimed subject matter can provide both high data rate and high capacity in a communication system. Not only is a high data rate for downstream possible but a high data for upstream is also possible. This can also work with low data rate if a very high system capacity is desired. An embodiment may also be used with high data rate bidirectional communication over an HFC network without incurring reduced capacity and incompatibility with the legacy cable system.

In the paragraphs that follow, the term signal corresponds to a modulated waveform with data or it may consist of a modulated portion and an unmodulated portion that are used for actual transmission and reception over various mediums such as copper cable, optical fiber, air, and the like. A signal can be either an electrical signal or an optical signal and one network may be made up of two or more networks to form a single network.

While maintaining high data rate communication, the capacity of embodiments of the claimed subject matter can be increased over the capacity of the traditional legacy system by utilizing the previously unused RF spectrum. No additional devices or blocks should need to be added to the users end equipment since the required RF front-end blocks are all built into user's end equipment. Legacy equipment and embodiments can coexist in a system, for instance from “legacy” type to “2×” or “3×” data-rate user end equipment provided that the system supports the maximum data rate. In the following descriptions of embodiments of the claimed subject matter, the embodiments and examples shown should be considered as exemplars, rather than as limitations of the claimed subject matter. Furthermore, reference to various features in any one ore more embodiments throughout this document does not mean that all claimed embodiments or methods must include the referenced feature.

In the paragraphs that follow, data corresponds to information in numerical form that can be solely information itself or also contain redundancy or extra information that can be processed to be useful, such as for error correction and other controlling purposes.

One embodiment of the claimed subject matter utilizes the cable frequency spectrum allocation shown in FIG. 5. While maintaining the legacy band 300 intact, two additional upstream bands (304 and 306) and one additional downstream band 305 are placed in the frequency range above the legacy band 300, which includes upstream band1 302 and downstream band1 303. The ranges of frequencies occupied by these additional bands 304,305, and 306 are determined or changed by a system architect considering required data rate improvement, capacity, ease and cost of implementation, and the like. Note that the individual physical channel widths, whether for upstream or downstream, can be the same as those of the legacy system or the widths can be different from those of the legacy system and varied dynamically so as to reduce network load and/or improve network reliability. For example, bands 304, and 305 of FIG. 5 can have channels widths shown respectively as in FIG. 5A, and FIG. 5B. A multiplicity of physical channels, whether for up stream or downstream, can be fixed or dynamically varied provided that the minimum guaranteed data transfer rate for a particular user is maintained. A system is normally constructed to provide a minimum guaranteed data rate to the participating users. For example, a system may be constructed so that the users are provided with 25 M bits per second (bps) under the worst-case scenario. Because the number of physical channels used for communication varies and each channel width may vary, a logical channel width, which is associated with the physical channels may also vary. Guard bands 307, which are defined as the frequency spacing between two neighboring bands, such as shown between bands 304 and 305 and between bands 305 and 306, are allocated in order to achieve required isolation between upstream and down stream communication.

Embodiments Related to Bidirectional High Data Rate Cable Systems

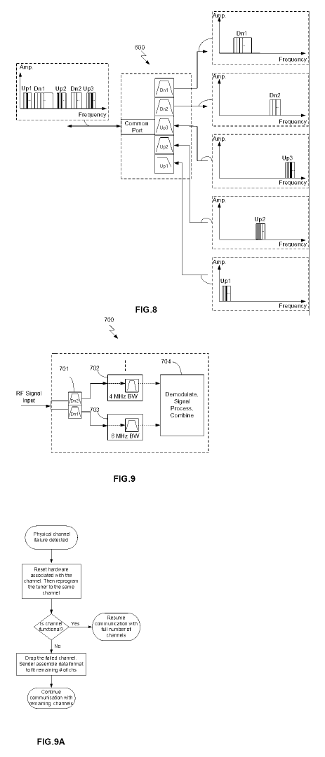

FIG. 6 illustrates an embodiment utilizing new band 407 placed above legacy band 406 and locations of multiple physical channels that can exist within the new band 407. One or more physical channels associated with a high data rate logical channel can exist entirely or partially in the new band 407, in the legacy band 406, or in both bands 406 and 407. In other words, downstream physical channels can be anywhere that is assigned as a downstream band and upstream physical channels can be anywhere that is assigned as an upstream band. If one or more downstream signals are sent over physical channels in the new band 407, one or more frequency converters 403 up convert the downstream signals to physical channels in the new band 407. If upstream signals are received from physical channels in the new band 407, one or more frequency converters 403 down convert the upstream signals to one ore more physical channels in the legacy band 406 or in a band whose highest frequency component can be processed by the high data rate capable head end 400. In other words, the bandwidth of the upstream portion of new band 407 does not need to be the same as that of the upstream portion of the legacy band 406 provided that the high data rate capable head end 400 is capable of processing the down-converted upstream portions of the new band 407. Embodiments can be used so that upstream signals are down converted to a band in which interference signals such as ingress, impulse nose, or/and common mode distortion can be avoided or in which the detrimental effect of such interference signals can be mitigated. Similarly, the bandwidth of the downstream portion of the new band 407 does not need to be the same as that of the bandwidth of the downstream portion of the legacy band 406 provided high data rate capable cable user end equipment 408 is capable of processing the bandwidth of downstream portion of the new band 407. To avoid RF related issues, multi-duplexer 410, which is a block made up with multiple frequency selective components (i.e. filters) can be inserted before the mixing process takes place in the one or more frequency converters 403. Multi-duplexer 410 will be described in detail in later section.

Fiber node 402 utilizes wavelength division multiplexing (WDM) to assign “colors” to information carrying signals. WDM may not be necessary if multiple fibers each are carrying a certain wavelength of light. By placing the frequency converter 403 external to the high data rate capable head end 400, an arrangement can be made so that the high data rate capable head end 400 has to deal with signals inside or in the close vicinity of the legacy band 406 and hence no hardware upgrades are needed for the high data rate capable head end 400, optical fiber network 401, and fiber node 402. The high data rate capable head end 400 contains one or more fiber nodes, which may use WDM, that convert the upstream optical signals back to electrical signals and convert the downstream electrical signals to optical signals. The high data rate capable head end 400 may contain other features/functions such as one or more frequency converters, filters, signal splitters/combiners, analog to digital converter(ADC)s, digital to analog converter (DAC)s, and other blocks, features, and/or functions (implemented in either hardware or software) that can be used to process signals and data.

In embodiments wherein high data rate communications are desired, high data rate capable head end 400 creates and assigns one ore more high data rate logical channels to one or more physical channels to help manage the flow of high data rate upstream and downstream communications. One or more signals may be sent in parallel, through one or more physical channels, but not necessarily simultaneously over the high data rate capable HFC network 409. As is the case for a prior art HFC network, the high data rate capable network 409 may contain elements such as optical amplifiers, hubs, splitters, etc. which are not shown in FIG. 6.

In an embodiment wherein the high data rate capable head end 400 sends out data bearing signals over one or more physical downstream channels, high data rate capable user end equipment 408 receives and demodulates the down stream signals. The demodulated data are then signal processed and combined to recover the high data rate downstream data. If required, data buffer or cache memory may be used for temporary data storage. Any necessary processing of recovering, or reconstructing the original source data from the received downstream signals may be done by a single stage defined as a data re-constructor.

In embodiments for transmission of high data rate upstream from high data rate capable user end equipment 408, data is first split and signal processed. After permission for transmission is granted by the high data rate capable head end 400, modulated (and frequency up converted, if necessary) upstream signals are sent via one or more upstream physical channels that are assigned by the high data rate capable head end 400. The high data rate capable head end 400 receives and demodulates the upstream signals sent over the high data rate capable HFC network 409 and head end 400 signal processes to recover the high data rate upstream data. High data rate capable head end 400 may also contain data buffer or cache memory for temporary data storage. The multiplicity of physical channels may be configured to help reduce communication latency.

In order to reduce the effect of burst errors, which occur frequently in practice, spreading of data over time, commonly known as interleaving can be used for both downstream and upstream data. Forward error correction (FEC) is very effective on errors that are spread apart in time.

Note that broadband distribution amplifiers 404 and broadband passives 405, for example splitters/combiners, taps, and the like, may need to be inserted to replace those of legacy HFC network to support the added high frequency bands. With existing technologies, the maximum frequency response of these broadband blocks can be up to 5 to 10 GHz.

FIG. 7. illustrates another embodiment in which up and down frequency conversions are taking place at high data rate capable head end 502. High data rate capable head end 502 consists of one or more high data rate capable CMTS 501, up/down converters 500, frequency selective blocks (e.g., multi-duplexer) 503, and optical nodes 504. In comparison to the previous embodiment, this embodiment may facilitate the transition to a high data rate capable service since up and down frequency conversion processes are not done by a frequency converter deployed in high data rate capable HFC network 512 but rather by a high data rate capable head end 502 located at a service provider. High data rate capable HFC network 512 consists of optical fiber network 505, optical node 506, wideband bidirectional amplifiers 507, wideband passive elements 508, and other necessary elements/features not shown in FIG. 7. As in the previous embodiment, high data rate capable user end equipment 511 may contain one or more frequency converters.

Embodiment Illustrating a Multi-Duplexer

A multi-duplexer is defined as a multi-port block whose signal that enters or leaves the common port is separated by frequency selective stages (i.e. filters) in one ore more prescribed ways. As illustrated in FIG. 8, multi-duplexer 600 is shown with two downstream bands and three upstream bands. Multi-duplexer 600 can be implemented with a set of inductive/capacitive elements (lumped or/and distributed), semiconductor integrated circuits, dielectric material filters, surface acoustic wave (SAW) filters, piezoelectric filters, ceramic filters, coupled cavities, crystal filters, Microelectromechanical (MEM) filters, or any combinations of the aforementioned. Multi-duplexer 600 may also contain switch elements for signal flow controlling purposes. Multi-duplexer 600 separates the frequency bands and provides high isolation between upstream and downstream paths. With the appropriate frequency planning, that is, with the proper selection of downstream and upstream band locations and associated guard bands, multi-duplexer 600 can be used by those skilled in the art to help mitigate other RF related impairments such as image/spurious mixing, non-linear effects that causes composite triple beat (CTB), composite second order (CSO), cross modulation (XMOD), and spurious signal emissions, and the like. For example, designing an upstream filter with center frequency of 1.7 GHz and bandwidth of 60 MHz and a downstream filter with center frequency of 2 GHz and bandwidth of 80 MHz is relatively easier, assuming the same isolation, than designing an upstream filter with center frequency of 1.9 GHz and bandwidth of 60 MHz and a downstream filter with center frequency of 2 GHz and bandwidth of 80 MHz because the filter pass bands of the former case are much farther apart.

Embodiments Illustrating Uses with Non-Legacy Communication Techniques

New spectrums placed in the frequency range, that were previously not used, pave the way for non-legacy communication techniques (e.g., non-DOCSIS or non-previous DOCSIS based in the case of communication over a HFC network.) These techniques include spectrum efficient modulation schemes and/or more advanced multiple access techniques which can be used without affecting existing technologies that are used in a legacy band. Examples of those non-legacy techniques may include Orthogonal Frequency Division Multiplexing (OFDM), multi carrier code division multiple access (MC-CDMA), and Hybrid FDMA/CDMA (FCDMA). Other advances may include techniques that allow the inclusion of more data into a single channel. It should be apparent to one skilled in the art that the current legacy techniques do not have to be permanently used for communication through the legacy band, rather, a gradual transfer to more advanced techniques would be desirable for communication through the legacy band utilizing proper planning involving both the legacy bands and the new bands.

Transmission and reception of signals at higher frequency often impose more stringent performance requirements on the RF component blocks. Examples of the most stringent requirement include the low noise figure (NF) required for the downstream and upstream RF blocks. If this instance, instead of implementing the blocks with high performance semiconductor processes which are often not cost effective, narrower channel bandwidth can be used to reduce the effect of thermal noise. For example, instead of using the traditional 6 MHz downstream channel width, a 4 MHz downstream channel width may be used and the resultant substitution would reduce the downstream tuner NF requirement by 10log(6/4)=1.72 dB. Thus, if a tuner with a 4 MHz channel bandwidth is used with a tuner with a 6 MHz channel bandwidth, the resulting maximum data rate will not be two times the previous legacy system utilizing 6 MHz channel bandwidth data rate, but rather 1.67 times the legacy system provided that other pertinent parameters remain the same.

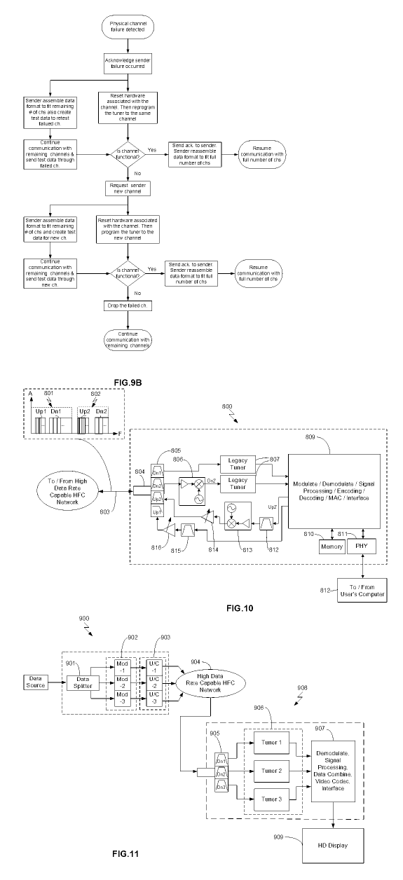

This example is shown in FIG. 9 wherein receiver 700 consists of duplexer 701 which separates legacy band Dn1 and new band Dn2, 4 MHz channel bandwidth tuner 702 which may include an additional down converter, 6 MHz channel bandwidth tuner 703, and data reconstructor 704 which performs demodulation, signal processing, and data combining to recover the data sent. The reduced channel width results in lower data rate transmission per channel. However, with more advanced techniques such as OFDM, it may be possible to achieve high data rate even with a narrow channel width. Nevertheless, the use of multiple physical channels for communication, as described in this present specification, can yield very high data rate even when a narrow channel width is used for each channel because the number of multiplicity can be arbitrarily increased as long as the implementation efforts remain reasonable.

Embodiments Illustrating Improved Communication Reliability

The use of multiple physical channels can be used to improve communication reliability. For instance, if one or more of multiple downstream paths becomes non-functional, the remainder of the one or more still functioning downstream channels can still be used so that the subscriber continues to receive downstream data. If a failure is detected, the receiver can acknowledge the sender by using one or more upstream channels and send a signal that the failure has occurred. In embodiments of the claimed subject matter, the sender could be either a head end or a user end, depending on the direction of communication. Similarly, a receiver could be either a head end or a user end, depending on the direction of communication. The sender may in turn processes the data accordingly to maintain communication with the remaining channels. The failed channel may be recoverable by such processes as the re-initialization of the hardware associated with the channel. If the failed channel cannot be recovered, a new channel can be assigned to the failed channel. Once the sender recognizes that the failed channel has either been recovered or that a new channel has been successfully assigned to the failed channel, the sender reassembles the data and resumes transmission using the full number of channels. If the failed channel is non-recoverable, the sender may continue sending data using the remaining channels at a reduced data rate.

FIG. 9A and FIG. 9B depict two possible scenarios after a channel failure is detected. In the first illustration FIG. 9A, the failed channel is reset before the sender makes the choice between dropping the failed channel or resuming communication with the full number of channels. In the second illustration, the procedures described above are completed. Prior art that uses single physical channel per upstream or downstream communications, such as a DOCSIS based cable modem or a DOCSIS based digital set top box, require, when encountering a channel failure, a hardware replacement or a hardware reset which results in the temporary cessation of communication in order to resume communication.

Embodiments Illustrating a High Data Rate Capable Cable Modem

FIG. 10 is a block diagram of an embodiment designated as high data rate capable cable modem 800. This particular embodiment has double the legacy data rate (2×) downstream and double the legacy data rate (2×) upstream capability. The F-connector 804 is connected to the high data rate capable HFC network through a single coaxial cable 803. No external frequency conversion unit is required as all the required blocks are integrated into the modem.

Multi-duplexer 805 separates the Dn1 legacy downstream band in legacy band 801, the Dn2 new downstream band in new band 802, the Up1 legacy upstream band in legacy band 801, and the Up2 new upstream band in new band 802 from each other. Multi-duplexer 805 also may provide high isolation between the upstream and downstream paths. The characteristics of the multi-duplexer 805, such as pass bandwidths, out of band rejections, and the like, can be set such that there would be mitigation of other RF related impairments such as image/spurious mixing, non-linear effects that causes composite triple beat (CTB), composite second order (CSO), cross modulation (XMOD), and spurious signal emissions.

In this embodiment, down-converter 806 takes one or more signals from one of the outputs of multi-duplexer 805, whose spectrum lies only around Dn2 in new band 802, and frequency converts the signals to band Dn2′ with the appropriate intermediate frequency (IF). The IF is selected so that the bandwidth of the downstream portion of new band 802 lies within, or close to legacy band 801 so that legacy tuners 807 can be reused and hence no high cost or high performance tuner is needed. Each of the legacy tuners 807 can be packaged into various forms, for example, each tuner 807 can be packaged into a small module that can be plug into an electrical socket without soldering so that replacement of failed unit can be easily accomplished. In this embodiment, the down-converted band, Dn2′ does not need to occupy the whole legacy downstream band, rather it only exists within or close to the legacy band so that legacy tuner 807 can operate. Embodiments may include a bandwidth of the downstream portion of new band 802 that is less than that of legacy band 801 so that linearity requirements of the downstream blocks are reduced. Legacy tuner 807 may produce intermediate frequency (IF) signals or I/Q baseband signals to data reconstructor 809 that follows. Down-converter 806 may be implemented as a set of discrete components or/and as an integrated circuit (IC) in various semiconductor processes such as bipolar junction transistor, silicon-germanium (SiGe), gallium arsenide (GaAs), or/and complementary metal-oxide semiconductor (CMOS). Down-converter 806 may include or consist of one or more of the following: a frequency converter, a local oscillator which is typically implemented as a frequency synthesizer utilizing phase-locked loop (PLL), a fixed gain, a variable gain amplifier, and other stages such as impedance matching or filtering. Legacy turner 807 may also include the down-conversion functionality. FIG. 10 illustrates an embodiment of a typical portioned system. The degree of amplification or gain of legacy tuner 807 and/or down-converter 806 are individually controlled by data reconstructor 809.

Data reconstructor 809 performs demodulation, modulation, encoding, decoding, equalization, media access control (MAC), and any other signal processing required. Data reconstructor 809 includes one or more ADCs that take outputs from legacy tuners 807 and produce digital signals which are subsequently demodulated and signal processed. In the aforementioned embodiments, the functional “boundary” between legacy tuner 807 and data reconstructor 809 can vary. For instance, legacy tuner 807 may contain A/D conversion elements and output unprocessed data to data reconstructor 809.

The demodulator's demodulation capability may be changed “on the fly”. For instance, the demodulator may demodulate a 256 QAM signal and after a software request, it may demodulate a 8 VSB signal. Similarly, data reconstructor 809 may dynamically support various multiple protocols. The data recovered from multiple physical channels are combined to recover the original source data that was being sent. For transmission of signals that are carrying high data rate data, the data is first split, individually encoded, modulated, and then converted to analog signals by one or more digital to analog converters (DACs). The modulators can be I/Q modulators or digital modulators whose output signal is ether at intermediate frequency (IF) or at radio frequency (RF). The modulator's modulating capability may also be changed “on the fly”. For instance, the modulator may modulate a 64 QAM signal and after a software request, it may produce a QPSK OFDM signal. In embodiments of the claimed subject matter, the frequency ranges of signals from the modulators do not need to be identical. The bands may be partially overlapped or even separated if the interactions between the bands cause unwanted effects such as spurious signal generation, degraded modulation quality, and the like.

Certain upstream or downstream channels that may not usable due to undesired interactions between the multiple paths can be avoided by having a lookup table and avoiding these problematic channels or by using dynamically, pre-determined in the design phase, or set/reset during operation “clean,” clearer or non-failing channels. Data reconstructor 809 may be implemented in various semiconductors processes and it may contain memory 810 and/or communication interface blocks 811.

BPF 812,815 provides filtering on the signals from the modulators. BPF 812,815 can be eliminated if adequate filtering can be done within data reconstructor 809. Up-converter 813 up converts the signal within band Up2′ to the new upstream band, Up2. Up-converter 813 can take signal at intermediate frequency (IF) or baseband signal. An I/Q modulation is used for the latter case. Up-converter 813 may be implemented as a set of discrete components or/and as an integrated circuit (IC) in various semiconductor processes such as bipolar junction transistor, silicon-germanium (SiGe), gallium arsenide (GaAs), or/and complementary metal-oxide semiconductor (CMOS) and it may consist of one or more of the following components: a frequency converter, a local oscillator which is normally implemented as a frequency synthesizer utilizing phase-locked loop (PLL), an amplifier, and any other stages such as impedance matching or filtering. The variable gain power amplifier can also integrate the up-conversion process. FIG. 10 is an illustration of an embodiment of a portioned system.

PA 814 and 816 amplify the incoming signals and the degree of amplification or gain of the stages are individually controlled by data reconstructor 809. The amplified signals are passed through the upstream portions of the multi-duplexer 805 where they then leave high data rate capable cable modem 800 and proceed to the high data rate capable HFC network. User's computer 817 can be connected to high data rate capable cable modem 800 through either by wireless or wired interface.

Embodiments Illustrating Uses with a High Data Rate Capable Digital TV/Set Top Box

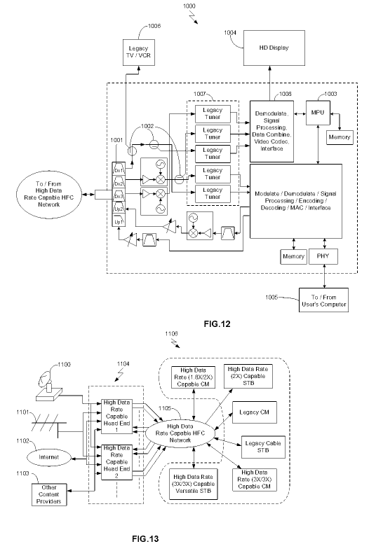

FIG. 11 depicts another user end embodiment in which high data rate data such as high definition TV (HDTV) data or TV over IP data is sent via a means of modulated RF and optical carrier signals over the high data rate capable HFC network 904. At the head end 900, the high data rate data is split into three data streams by serial to parallel converter/data splitter 901. Each data stream modulates a carrier signal by modulator 902 and then is up-converted, if needed, to RF signals by up converter 903. One modulator element may provide modulation and up-conversion on the multiple data streams. In one embodiment, one of the up conversions is done to the legacy band and the rest of the up conversions are up converted to the one or more new bands. Another embodiment may include up converting all the signals to the one or more new bands, leaving the legacy band intact. This latter example may be desirable if one wishes to maintain a legacy analog TV channel assignment. The former example may be advantageous in that it can support subscribers with legacy user end equipment (e.g., 1× data rate equipment).

At high data rate capable cable digital TV/set top box 908, the RF signal passes through element 905 which may be implemented as a band-pass filter bank or a multi-duplexer with the upstream ports properly terminated. Tuner bank 906 tunes to the logical channel which has associated multiple physical channels and Tuner bank 906 frequency converts/amplifies/filters out the signals as needed. Tuner bank 906 gains are individually controlled by data reconstructor 907. As in the previous embodiment, each tuner in tuner bank 906 can be packaged into various forms. For instance, each tuner can be packaged into a small module that can be plug into an electrical socket without soldering so that replacement of failed unit can be easily accomplished. Data reconstructor 907 performs demodulation, equalization, error detection/correction, security check, data combining, and any other required processes. The data reconstructor 907 may also contain video codec functionality and one ore more interfaces to data storage devices. Again, the functional “boundary” between tuner bank 906 and Data reconstructor 907 can vary. For instance, tuner bank 906 may contain A/D conversion elements and output unprocessed data to data reconstructor 907. The recovered high data rate HDTV data is displayed on HD display 909.

The HD display 909 can be either external or part of to the high data rate capable digital TV/set top box 908. If the HD display 909 is external to high data rate capable digital TV/set top box 908, the HD display 909 can be connected to the high data rate capable digital TV/set top box 908 via a wireless or wired interface. The tuner bank 906 can be used in such ways that a viewer can view a channel that is different from the main channel being displayed (i.e., a picture in picture feature) or a viewer may record a channel different from the main channel being displayed (i.e., background recording).

Embodiments Illustrating a High Data Rate Capable Versatile Set Top Box

FIG. 12 depicts another embodiment, termed a high data rate capable versatile set top box 1000, in which high data rate capable cable modem (with 2× upstream/2× down stream capabilities) is combined with high data rate (3×) capable digital TV STB functionality. In this embodiment, multi-duplexer 1001 accepts a RF signal from a high data rate capable network and separates the downstream bands to Dn1 (legacy downstream band), Dn2 (new down stream band 1), and Dn3 (new downstream band 2) in the frequency domain. Multi-duplexer 1001 also accepts upstream signals and separates upstream bands to Up1 (legacy upstream band) and Up2 (new upstream band). Multi-duplexer 1001 provides the required isolation between the upstream and the downstream signals. Signal splitter 1002 takes a signal and outputs two or more split signals. Signal splitter 1002 can be implemented as a passive and/or active block and signal splitter 1002 can be placed before or after one ore the down-conversion stages, depending on RF performance tradeoffs. One or more signal splitters 1002 may feed a set of channels in legacy band to legacy TV/VCR 1006. The legacy tuners 1007 that are connected to the video demodulator element 1008 may be configured so that picture-in-picture viewing or/and background recording is possible. In this embodiment, data reconstruction capability is built into high data rate capable video element 1008 and/or cable modem element 1009. As in the previous embodiments, each of legacy tuners 1007 can be packaged into various forms. For instance, each tuner can be packaged into a small module that can be plug into an electrical socket without soldering so that replacement of failed unit can be easily accomplished. A system controller element, such as a micro processor, MPU 1003 may be used for managing and controlling the overall system. High definition (HD) display 1004 is connected to the high data rate capable video element 1008 and it can be either external to or part of high data rate capable versatile set top box 1000. If the HD display 1004 is external to high data rate capable versatile set top box 1000, the HD display 1004 can be connected to the high data rate capable versatile set top box 1000 via a wireless or wired interface. User's computer 1005 can be either external or integrated into high data rate capable versatile set top box 1000. If user's computer 1005 is external to high data rate capable versatile set top box 1000, user's computer 1005 can be connected to the high data rate capable versatile set top box 1000 through a wireless or wired interface. Data recovered from the high data rate capable cable element 1009 can be viewed on the HD display 1004 using application software such as a Web browser, an email client, or a media player installed on user's computer 1005. User's computer 1005 may be controlled by a keyboard (either wired or wireless), a mouse (either wired or wireless), and/or other various controlling/interface devices. The high data rate capable versatile set top box 1000 may also have an operating system independent from the operating system installed on user's computer 1005.

Embodiments Illustrating the Coexistence of Various High Data Rate Capable Equipment with Various Legacy Equipment.

FIG. 13 illustrates a situation in which various high data rate capable equipment coexist with legacy equipment. A set of high data rate capable head ends 1104 connects to data sources such as satellite TV 1100, terrestrial TV 1101, internet 1102, and other content providers 1103. A set of high data rate capable head ends 1104 interfaces with high data rate capable HFC network 1105 and high data rate capable HFC network 1105 provides and receives signals to/from a set of user ends consist of various high data rate capable equipment and legacy equipment 1106.

When a user end first participates with high data rate capable HFC network 1105, it goes through a number of initialization steps. For example, these steps include channel acquisition, ranging, downloading of operational parameters, and registration with the head end. In the initialization processes, the user end supplies its information including the type of equipment being used (e.g., 2× downstream/2× upstream) to the head end so that the head end can keep track of types of the user end equipment and the number of each that are connected to the network.

To facilitate the initialization process, all or some of user ends joining high data rate capable HFC network 1105 may first register as legacy user end equipment. Only after the head end is communicated the type of the equipment being used and the type of service the user wish to subscribe to, minimum and maximum communication data rates and types of communication and protocol are determined and communication can be commenced at a proper rate. The user information can be stored for future use in a memory block, such as flash memory, which resides within the high data rate capable user end. In some embodiments, users of high data rate capable user ends can choose to receive and/or send data at a low data rate, such as when the end user would receive a reduced fee. The user end could also choose to receive and/or send data at a low data rate during peak system hours when usage rates may be higher. In such embodiments, the change of minimum data rate can be done “on demand” by one or more head end sending control signals and disabling some of multiple receive/transmit blocks in the high data rate capable user ends.

Similarly, some users of high data rate capable user ends may prefer not to subscribe to some services that the content/service provider offers. An example is a situation wherein a user prefers not to view one or more movie channels. By allocating the movie channels to a new band, the high data rate capable user end can effectively block those un-needed channels. It can also accomplish this by disabling one or more of the receive paths.

For example, entire Dn3 band in FIG. 12 can be assigned for movie channels. For users who wish not to view the channels, the down converter and the following tuner stages are disabled. This disabling and enabling of blocks can be done “on demand” by communicating with head end, and therefore, no field personnel need to be sent to the customer's premise to manually block or enable one or more channels. In one embodiment, a user could purchase a cable modem which supports the legacy system and the new system as described in this specification. The user could elect to pay the standard rate for the legacy system or the increased or premium rate to access the advanced system. The system could also allow a user to “roam” into the legacy band if the new advanced system is not available for some reason. This system would be analogous to a cell phone user a cell phone with a dual mode capability such as digital and analog, wherein the user roams into an analog band if he or she is not in a digital zone.

An “on demand” feature using the flexibility and expandability of high data rate capable head end set 1104 and high data rate capable HFC network 1105 may benefit the content/service provider's business as well. With a sufficiently high frequency response and network capacity of high data rate capable HFC network 1105 established, high data rate capable head end can be configured/upgraded to support future higher multiplicity or improved communications without discarding services for legacy or “old” high data rate capable user ends. In this way, the service provider is able to retain the “old” legacy system subscribers while at the same time add new subscribers to both the old system and the new improved “premium” system. This would result in much higher return on investment compared to re-building an existing HFC network every time an upgrade is required due to new features. This will also lead to a decrease in system downtime and an increase in customer retention and satisfaction.

Embodiments Illustrative Uses with Non-Cable and Wireless Systems

Embodiments of the claimed subject matter can be used with other communication systems such a cellular phone system, a wireless local area network (LAN) system, and a satellite communication system. For example, some existing cellular phone systems use 900 MHz and 2 GHz band. One or more new bands in the unused frequency or unlicensed bands can also be added to the one or more bands that are currently being utilized in a existing communication system.

Unlike the propagation through coaxial cables and optical fibers, propagation through the “air” at high frequency may incur problems such as high loss, multi-path phenomena, and the like which would add technical challenges to the system.

However, future technological advances in areas such as digital signal processing, semiconductor devises, antenna design, and other areas may help make it economically feasible to design and operate a communication system capable of offering features such as high data rate, high capacity, and increased reliability using embodiments of the claimed subject matter.

Another embodiment can use an added band to send and/or receive redundant data and this additional band can be used for other improvements such as to implement diversity and therefore, to improve the quality of the communications. Future advances in communication technologies may result in elimination of one or more intermediate elements or steps in embodiments of the claimed subject matter.

What is claimed is:

1. A communication system comprising:
a network having a legacy band and an extendable frequency band;
a head end; and
a user end;
wherein said head end processes and splits source data into multiple signals and transmits said multiple signals over multiple physical channels over said extendable frequency band; and
wherein said user end containing multiple receivers and a data reconstructor receives said multiple signals and recovers said source data.

2. The communication system of claim 1, wherein said network is a wireless network.

3. The communication system of claim 1, wherein said network is a wired network.

4. The communication system of claim 1, wherein said network is a wired and a wireless network.

5. The communication system of claim 3, wherein said network is a HFC network.

6. The communication system of claim 1, wherein said network is a HFC and a wireless network.

7. The communication system of claim 1, wherein said signals are modulated signals.

8. The communication system of claim 1, wherein said signals consist of modulated and un-modulated signals.

9. The communication system of claim 1, wherein said extendable frequency band is more than one extendable frequency bands.

10. The communication system of claim 1, wherein said head end is more than one head ends.

11. The communication system of claim 1, wherein said user end is more than one user ends.

12. The communication system of claim 1, wherein said legacy band is more than one legacy bands.

13. The communication system of claim 1, wherein said system is compatible with a legacy system.

14. The communication system of claim 1, wherein said system is scalable.

15. The communication system of claim 14, wherein said system's scalability is non-dynamically variable.

16. The communication system of claim 14, wherein said system's scalability is dynamically variable.

17. The communication system of claim 14, wherein said system's scalability is static with one or more predetermined values.

18. The communication system of claim 1, wherein said system utilizes one or more logical channels which are associated with said multiple physical channels.

19. The communication system of claim 1, wherein said user end containing multiple receivers and a data reconstructor receives said multiple signals, recovers said source data, and outputs said source data.

20. The communication system of claim 1, wherein said system utilizes DOCSIS in said legacy band and non-DOCSIS in said extendable band.

21. The communication system of claim 1, wherein said system utilizes non-DOCSIS in legacy band and DOCSIS in said extendable band.

22. The communication system of claim 1, wherein said system utilizes non-DOCSIS in legacy band and non-DOCSIS in said extendable band.

23. The communication system of claim 1, wherein said system utilizes DOCSIS in said legacy band and DOCSIS in said extendable band.

24. The communication system of claim 1, wherein said system utilizes both DOCSIS and non-DOCSIS in said legacy band.

25. The communication system of claim 1, wherein said system utilizes both DOCSIS and non-DOCSIS in said extendable band.

26. The communication system of claim 1, wherein said system utilizes a single channel in either said legacy band or said extendable band.

27. A communication system comprising:
a network having a legacy band and an extendable frequency band;
a head end; and
a user end;
wherein said user end processes and splits source data into multiple signals and transmits said multiple signals over multiple physical channels over said extendable frequency band; and
wherein said head end receives said multiple signals and recovers said source data.

28. The communication system of claim 27, wherein said network is a wireless network.

29. The communication system of claim 27, wherein said network is a wired network.

30. The communication system of claim 27, wherein said network is a wired and a wireless network.

31. The communication system of claim 29, wherein said network is a HFC network.

32. The communication system of claim 27, wherein said network is a HFC and a wireless network.

33. The communication system of claim 27, wherein said signals are modulated signals.

34. The communication system of claim 27, wherein said signals consist of modulated and un-modulated signals.

35. The communication system of claim 27, wherein said extendable frequency band is more than one extendable frequency bands.

36. The communication system of claim 27, wherein said head end is more than one head ends.

37. The communication system of claim 27, wherein said user end is more than one user ends.

38. The communication system of claim 27, wherein said legacy band is more than one legacy bands.

39. The communication system of claim 27, wherein said system is compatible with a legacy system.

40. The communication system of claim 27, wherein said system is scalable.

41. The communication system of claim 40, wherein said system's scalability is non-dynamically variable.

42. The communication system of claim 40, wherein said system's scalability is dynamically variable.

43. The communication system of claim 40, wherein said system's scalability is static with one or more predetermined values.

44. The communication system of claim 27, wherein said system utilizes one or more logical channels which are associated with said multiple physical channels.

45. The communication system of claim 27, wherein said user end containing multiple receivers and a data reconstructor receives said multiple signals, recovers said source data, and outputs said source data.

46. The communication system of claim 27, wherein said system utilizes DOCSIS in said legacy band and non-DOCSIS in said extendable band.

47. The communication system of claim 27, wherein said system utilizes non-DOCSIS in legacy band and DOCSIS in said extendable band.

48. The communication system of claim 27, wherein said system utilizes non-DOCSIS in legacy band and non-DOCSIS in said extendable band.

49. The communication system of claim 27, wherein said system utilizes DOCSIS in said legacy band and DOCSIS in said extendable band.

50. The communication system of claim 27, wherein said system utilizes both DOCSIS and non-DOCSIS in said legacy band.

51. The communication system of claim 27, wherein said system utilizes both DOCSIS and non-DOCSIS in said extendable band.

52. The communication system of claim 27, wherein said system utilizes a single channel in either said legacy band or said extendable band.

53. A method of communication over a network having a legacy band and an extendable frequency band comprising the steps of:
processing and splitting source data into multiple signals using a head end;
using said head end to transmit said multiple signals over multiple physical channels in said extendable frequency band;
receiving said multiple signals with a user end, said user end containing multiple receivers and a data reconstructor; and
recovering said source data using said data reconstructor.

54. The method of claim 53, wherein said network is a wireless network.

55. The method of claim 53, wherein said network is a wired network.

56. The method of claim 53, wherein said network is a wired and a wireless network.

57. The method of claim 55, wherein said network is a HFC network.

58. The method of claim 53, wherein said network is a HFC and a wireless network.

59. The method of claim 53, wherein said signals are modulated signals.

60. The method of claim 53, wherein said signals consist of modulated and un-modulated signals.

61. The method of claim 53, wherein said extendable frequency band is more than one extendable frequency band.

62. The method of claim 53, wherein said head end is more than one head ends.

63. The method of claim 53, wherein said user end is more than one user ends.

64. The method of claim 53, wherein said legacy band is more than one legacy bands.

65. The method of claim 53, wherein said system is compatible with a legacy system.

66. The method of claim 53, wherein said system is scalable.

67. The method of claim 66, wherein said system's scalability is non-dynamically variable.

68. The method of claim 66, wherein said system's scalability is dynamically variable.

69. The method of claim 66, wherein said system's scalability is static with one or more predetermined values.

70. The method of claim 53, wherein said system utilizes one or more logical channels which are associated with said multiple physical channels.

71. The method of claim 53, wherein said user end containing multiple receivers and a data recoverer receives said multiple signals, recovers said source data, and outputs said source data.

72. The method of claim 53, wherein said method utilizes DOCSIS in said legacy band and non-DOCSIS in said extendable band.

73. The method of claim 53, wherein said method utilizes non-DOCSIS in legacy band and DOCSIS in said extendable band.

74. The method of claim 53, wherein said method utilizes non-DOCSIS in legacy band and non-DOCSIS in said extendable band.

75. The method of claim 53, wherein said method utilizes DOCSIS in said legacy band and DOCSIS in said extendable band.

76. The method of claim 53, wherein said method utilizes both DOCSIS and non-DOCSIS in said legacy band.

77. The method of claim 53, wherein said method utilizes both DOCSIS and non-DOCSIS in said extendable band.

78. The method of claim 53, wherein said method utilizes a single channel in either said legacy band or said extendable band.

79. A method of communication over a network having a legacy band and an extendable frequency band comprising the steps of:
using a user end to process and split source data into multiple signals and to transmit said multiple signals over multiple physical channels over said extendable frequency band;
using a head end to receive said multiple signals and recover said source data from said multiple signals.

80. The method of claim 79, wherein said network is a wireless network.

81. The method of claim 79, wherein said network is a wired network.

82. The method of claim 79, wherein said network is a wired and a wireless network.

83. The method of claim 81, wherein said network is a HFC network.

84. The method of claim 79, wherein said network is a HFC and a wireless network.

85. The method of claim 79, wherein said signals are modulated signals.

86. The method of claim 79, wherein said signals consist of modulated and un-modulated signals.

87. The method of claim 79, wherein said extendable frequency band is more than one extendable frequency band.

88. The method of claim 79, wherein said head end is more than one head ends.

89. The method of claim 79, wherein said user end is more than one user ends.

90. The method of claim 79, wherein said legacy band is more than one legacy bands.

91. The method of claim 79, wherein said system is compatible with a legacy system.

92. The method of claim 79, wherein said system is scalable.

93. The method of claim 92, wherein said system's scalability is non-dynamically variable.

94. The method of claim 92, wherein said system's scalability is dynamically variable.

95. The method of claim 92, wherein said system's scalability is static with one or more predetermined values.

96. The method of claim 79, wherein said system utilizes one or more logical channels which are associated with said multiple physical channels.

97. The method of claim 79, wherein said user end containing multiple receivers and a data recoverer receives said multiple signals, recovers said source data, and outputs said source data.

98. The method of claim 79, wherein said method utilizes DOCSIS in said legacy band and non-DOCSIS in said extendable band.

99. The method of claim 79, wherein said method utilizes non-DOCSIS in legacy band and DOCSIS in said extendable band.

100. The method of claim 79, wherein said method utilizes non-DOCSIS in legacy band and non-DOCSIS in said extendable band.

101. The method of claim 79, wherein said method utilizes DOCSIS in said legacy band and DOCSIS in said extendable band.

102. The method of claim 79, wherein said method utilizes both DOCSIS and non-DOCSIS in said legacy band.

103. The method of claim 79, wherein said method utilizes both DOCSIS and non-DOCSIS in said extendable band.

104. The method of claim 79, wherein said method utilizes a single channel in either said legacy band or said extendable band.

105. A data over cable modem capable of receiving increased data comprising:
a multi duplexer for separating a received signal into a portion contained within a first band and a portion contained within a second additional band;
a downstream converter coupled to said multi duplexer for frequency converting that portion of the signal contained in the additional band;
a first tuner coupled to the multi duplexer for receiving that portion of the signal contained in the first band and extracting out a channel signal therein; and
a second tuner coupled to the downstream converter for receiving the frequency-converted portion of the signal and extracting out a channel signal therein.

106. The data over cable modem of claim 105 further comprising:
a demodulator/decoder coupled to the first and second tuners for receiving the channel signals and recovering data from each channel signal and thereafter combining said data into a single data stream.

107. The data over cable modem of claim 105 wherein the first band is the legacy band.

108. The data over cable modem of claim 107 wherein the downstream converter converts that portion of the signal contained in the additional band to a lower frequency within the legacy band.

109. The data over cable modem of claim 106 further comprising:
a third tuner coupled to the multi duplexer for receiving that portion of the signal contained in the first band and extracting out an additional channel signal therein; and
a fourth tuner coupled to the downstream converter for receiving the down-converted portion of the signal and extracting out an additional channel signal therein.

110. The data over cable modem of claim 109 wherein the demodulator/decoder is further coupled to the third and fourth tuners for receiving the additional channel signals and recovering data from each additional channel signal, thereafter combining said data into a second single data stream.

111. A data over cable modem capable of transmitting increased data comprising:
an encoder/modulator coupled for receiving, encoding, and modulating data into at least two channel signals for transmission over a first channel within a first frequency band and transmission over a second channel within an additional frequency band;
an upstream converter coupled to said encoder/modulator for frequency converting the second channel signal up a frequency within the additional frequency band;
a multi duplexer for sending out both the channel signal contained within the first frequency band and the second channel signal within the additional frequency band.

112. The data over cable modem of claim 111, wherein the first band is the legacy band.

113. The data of cable modem of claim 112, wherein the additional frequency band is of a frequency higher than the legacy band.

114. The data over cable modem of claim 112 wherein the upstream converter converts that portion of the signal within the legacy band to an additional band having a higher frequency such that said additional band has an intermediate frequency higher than the legacy band.

115. A communications system comprising:
a high data rate cable head end having;
an encoder/modulator coupled for receiving, encoding, and modulating data into signals for transmission over both a first channel within a first frequency band and transmission over a second channel within an additional frequency band;
an upstream converter coupled to said encoder/modulator for frequency converting the second channel signal up to a frequency within the additional frequency band;
a multi duplexer for sending out the first channel signal contained within the first frequency band and the second channel signal within the additional frequency band;
a data over cable modem capable of receiving increased data and having;
a multi duplexer for separating the received first channel signal contained within the first frequency band and the second channel signal contained within the additional frequency band;
a downstream converter coupled to said multi duplexer for frequency converting the signal contained within the additional frequency band down to a frequency within the first frequency band;
a first tuner coupled to the multi duplexer for receiving the signal contained in the first frequency band and extracting out a channel signal therein; and
a second tuner coupled to the downstream converter for receiving the frequency-converted signal and extracting out a channel signal therein.

116. The system of claim 115 wherein the data over cable modem further includes a demodulator/decoder coupled to the first and second tuners for receiving the channel signals and recovering data from each channel signal and thereafter combining said data into a single data stream.

117. The system of claim 115 wherein the first band is the legacy band.

118. The system of claim 117 wherein the upstream converter of the high data rate cable head end converts that portion of the signal within the legacy band to an additional band having a higher frequency such that said additional band has an intermediate frequency higher than the legacy band.

119. The data over cable modem of claim 117 wherein the downstream converter of the data over cable modem converts the signal contained in the additional frequency band to a lower frequency within the legacy band.

120. A communications system comprising:
a high data rate cable head end having;
a multi duplexer for separating a received signal into a portion contained within a first band and a portion contained within a second additional band;
a downstream converter coupled to said multi duplexer for frequency converting that portion of the signal contained in the additional band; and
a data over cable modem capable of transmitting increased data and having;
an encoder/modulator coupled for receiving, encoding, and modulating data into at least two channel signals for transmission over a first channel within a first frequency band and transmission over a second channel within an additional frequency band;
an upstream converter coupled to said encoder/modulator for frequency converting the second channel signal up to the additional frequency band;
a multi duplexer for sending out both the channel signal within the first frequency band and the channel signal within the additional frequency band.

121. The system of claim 120 wherein the first band is the legacy band.

122. The system of claim 120 wherein the additional frequency band is of a frequency higher than the legacy band.

123. The system of claim 120 wherein the high data rate cable head end further includes a demodulator/decoder for receiving the channel signals and recovering data from each channel signal and thereafter combining said data into a single data stream.
